(19) United States
(12) Patent Application Publication
(10) Pub. No.: US 2026/0079010 A1
(43) Pub. Date: Mar. 19, 2026

(54) OWN POSITION ESTIMATION DEVICE

(71) Applicant: HITACHI ASTEMO, LTD., Hitachinaka-shi, Ibaraki (JP)

(72) Inventor: Takahiro YAMADA, Hitachinaka-shi, Ibaraki (JP)

(73) Assignee: HITACHI ASTEMO, LTD., Hitachinaka-shi, Ibaraki (JP)

(21) Appl. No.: 19/106,900

(22) PCT Filed: Sep. 5, 2022
(86) PCT No.: PCT/JP2022/033309

§ 371 Date: Feb. 26, 2025

(51) Int. Cl. G01C 21/28; G01S 19/49

(52) U.S. Cl. CPC G01C 21/28; G01S 19/49

(57) ABSTRACT

An own position estimation device includes: a position information acquisition unit in a vehicle; a first memory in which encrypted map information is stored; a microcomputer that reads the map information, performs calculation based on information obtained from the position information acquisition unit, and outputs driving assistance information; and a second memory that retains the map information and current position information transferred by the microcomputer. The position information acquisition unit, the first memory, and the second memory are connected to the microcomputer through a communication line, and the second memory is a non-volatile memory of the vehicle, and stores own position information, encrypted peripheral map information, and decrypted peripheral map information during an operation of the vehicle.

### TECHNICAL FIELD

The present invention relates to an own position estimation device and a driving assistance device, and for example, relates to an own position estimation device that loads map data into a non-volatile memory for driving assistance and a driving assistance device having an own position estimation function.

### BACKGROUND ART

In recent years, a large number of non-volatile memories characterized by a large number of times of rewriting have been realized, and some of the non-volatile memories have been commercialized. Typical examples thereof include a magnetoresistive memory (MRAM), a ferroelectric memory (FeRAM), a resistance change memory (ReRAM), a phase change memory (PRAM), and a carbon nanotube memory (NRAM). Since the memory has a large number of times of rewriting and non-volatility, application in various applications is expected.

A device using such a non-volatile memory, there is a device disclosed in PTL 1. This publication discloses a control method for obtaining access performance in a case where a FeRAM or the like is used as a RAM. In addition, PTL 2 discloses a case where a FeRAM is used as a storage area in which a program is written.

### CITATION LIST

### Patent Literature

PTL 1: JP 2020-21450 A

PTL 2: JP 2019-185398 A

### SUMMARY OF INVENTION

### Technical Problem

In recent years, there is an increasing need for an own position estimation function in a driving assistance function of an automobile. This is because driving assistance based on the own position and map data corresponding to the own position is required, including the mandatory support for ISA (Intelligent Speed Assistance) in Europe.

However, the conventional own position estimation device has various problems, and among the problems, there are two particularly large problems. One is a length of time from activation to time when own position information can be used for driving assistance. This is because it takes time to calculate position information from a GNSS, and it is necessary to acquire and develop peripheral map information after estimation of the own position information is completed. Thus, it is not possible to perform driving assistance based on the own position information for a predetermined period after the ignition is turned ON.

The other is that a large-capacity memory is required to handle a large capacity of map data, and in particular, in an inexpensive microcomputer that does not have a DRAM I/F, it is not possible to process the map data due to a small RAM capacity, and thus an expensive SoC is required. In particular, the latter causes the own position estimation device to be expensive, and is one of factors that hinder the spread of more highly functional driving assistance.

### Solution to Problem

An example of an own position estimation device according to the present invention includes: a position information acquisition unit in a vehicle; a first memory in which encrypted map information is stored; a microcomputer that reads the map information, performs calculation based on information obtained from the position information acquisition unit, and outputs driving assistance information; and a second memory that retains the map information and current position information transferred by the microcomputer. The position information acquisition unit, the first memory, and the second memory are connected to the microcomputer through a communication line, and the second memory is a non-volatile memory of the vehicle, and stores own position information, encrypted peripheral map information, and decrypted peripheral map information during an operation of the vehicle.

An example of a driving assistance device according to the present invention includes: the own position estimation device described above, and has an own position estimation function, and a function of performing driving assistance by using an own position estimated by the own position estimation function.

### Advantageous Effects of Invention

By using the own position estimation device according to the example of the present invention, it is possible to handle map data in a system using an inexpensive microcomputer that does not have a DRAM I/F, so that it is possible to reduce the cost of the own position estimation device.

In addition, by using the own position estimation device according to the example of the present invention, it is possible to acquire peripheral map information from the outside through the Internet or the like and perform calculation, in a system using an inexpensive microcomputer that does not have a DRAM I/F. As a result, it is possible to reduce the cost of the own position estimation device.

In addition, by using the own position estimation device according to the example of the present invention, it is possible to avoid a risk of extracting map information from the own position estimation device after traveling.

In addition, by using the own position estimation device according to the example of the present invention, it is possible to start driving assistance by own position estimation soon after activation, and an effect of realizing the driving assistance from the start of driving can be obtained.

In addition, as in the driving assistance device according to the example of the present invention, it is also possible to integrate a device on a side on which an own position estimation function is provided, and a device on a side in which the driving assistance is performed by using information provided by the own position estimation device.

### BRIEF DESCRIPTION OF DRAWINGS

FIG. 1 is a configuration of an own position estimation device according to Example 1.

FIG. 2 illustrates a memory configuration and data movement of the own position estimation device according to Example 1.

FIG. 3 is a flowchart illustrating a flow of an operation of the own position estimation device according to Example 1.

FIG. 4 is a configuration of an own position estimation device according to Example 2.

FIG. 5 is a flowchart illustrating a flow of an operation of an own position estimation device according to Example 3.

FIG. 6 is a flowchart illustrating a flow of an operation of an own position estimation device according to Example 4.

### DESCRIPTION OF EMBODIMENTS

Hereinafter, Examples 1 to 4 for an own position estimation device and Example 5 for a driving assistance device will be described with reference to the drawings.

### Example 1

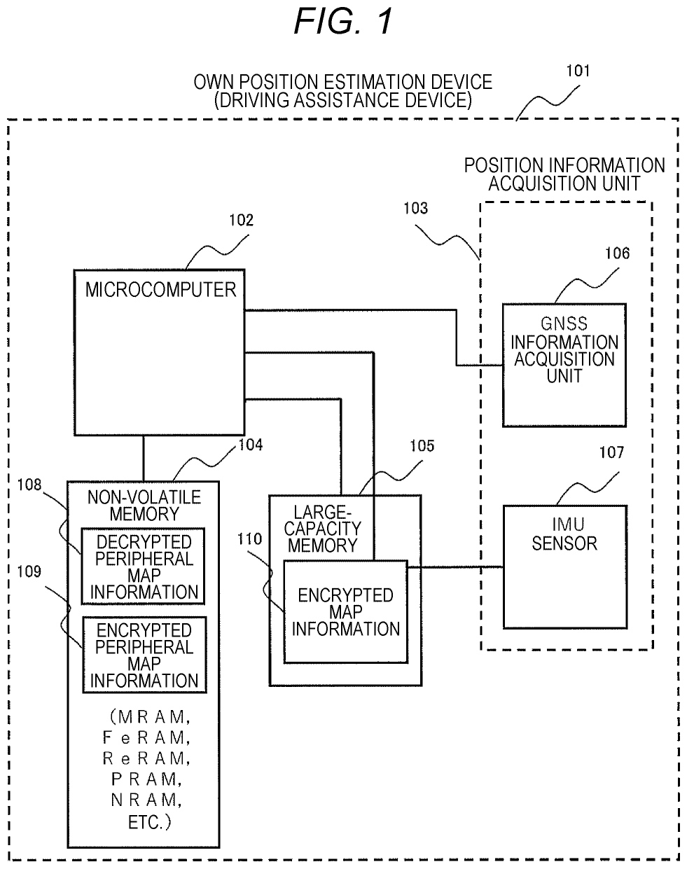

FIG. 1 illustrates a configuration of an own position estimation device according to Example 1 of the present invention. An own position estimation device 101 includes a microcomputer 102, a position information acquisition unit 103 in a vehicle, a non-volatile memory 104 (second memory), and a large-capacity memory 105 (first memory) therein. The microcomputer 102 includes a processor. The position information acquisition unit 103 includes a sensor group related to position information acquisition, and includes, for example, a global navigation satellite system (GNSS) information acquisition unit 106 and an inertial measurement unit (IMU) sensor 107. The GNSS information acquisition unit 106 can acquire information provided by satellite navigation.

The position information acquisition unit 103 (more specifically, the GNSS information acquisition unit 106 and the IMU sensor 107), the non-volatile memory 104, and the large-capacity memory 105 are each connected to the microcomputer 102 through a communication line.

The large-capacity memory 105 stores encrypted map information. For example, the large-capacity memory 105 stores encrypted map information 110 of a wide area. The non-volatile memory 104 stores peripheral map information. The peripheral map information includes encrypted peripheral map information 109 obtained by copying a necessary part from the encrypted map information 110, and decrypted peripheral map information 108 created by decrypting the encrypted peripheral map information.

The non-volatile memory 104 can be an MRAM, an FeRAM, a ReRAM, a PRAM, or an NRAM. The use of these memories is preferable in that the number of times of rewriting is very large. The large-capacity memory 105 is a non-volatile memory having low price and a large capacity, such as a NAND Flash, but is not limited to the described memory as long as the memory has this characteristic.

In addition, the GNSS information acquisition unit 106 and the IMU sensor 107 have been described as the example of the position information acquisition unit 103, but this is a representative example of a sensor that can be used for position information acquisition, and the type of sensor is not limited thereto. For example, the sensor may be a sensor using a camera.

Furthermore, for the encrypted map information 110 and the encrypted peripheral map information 109, the “encryption” does not limit the encryption scheme. In addition, not so-called encryption but obfuscation may be included. For example, even if it does not apply to a specific definition of the term “encryption”, it is sufficient that it is difficult to read the map information as compared with the map information before processing. As a specific example, information in a state where reading can be performed by predetermined calculation without knowing a key for decryption is included.

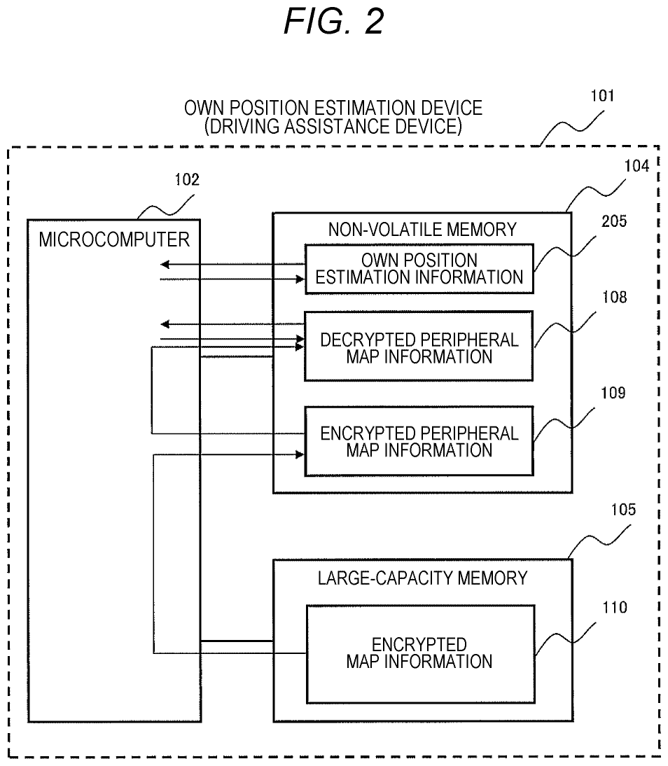

FIG. 2 illustrates a memory configuration and data movement of the own position estimation device 101 according to the present example. FIG. 2 is particularly described focusing on data movement of the own position estimation device 101.

The own position estimation device 101 in the present embodiment first copies encrypted map information of a predetermined range around the own position from the encrypted map information 110 stored in the large-capacity memory 105 to the non-volatile memory 104 as the encrypted peripheral map information 109, based on the own position estimation information (for example, information indicating the estimated own position of the vehicle). At this time, since the data is sequentially transferred, there is no problem even if the RAM size of the microcomputer 102 itself is smaller than the data size of the encrypted peripheral map information 109.

Then, data included in the encrypted peripheral map information 109 is sequentially read by the microcomputer 102 and is written into the non-volatile memory 104 as the decrypted peripheral map information 108. Also at this time, since the data is sequentially transferred and processed, there is no problem even if the RAM size of the microcomputer 102 itself is smaller than the data size of the encrypted peripheral map information 109 or the decrypted peripheral map information 108.

The non-volatile memory 104 stores own position estimation information 205 (own position information) representing the estimated own position of the vehicle, and the microcomputer 102 can read and write the own position estimation information 205. The own position estimation information 205 can be obtained from the position information acquisition unit 103, for example.

As described above, the non-volatile memory 104 retains the map information (for example, the encrypted peripheral map information 109 and the decrypted peripheral map information 108) and the current position information (for example, the own position estimation information 205) transferred by the microcomputer 102.

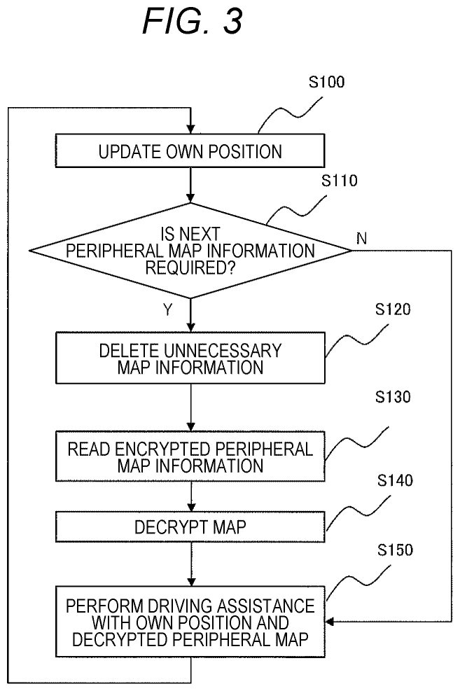

FIG. 3 is a flowchart illustrating a flow of the operation of the own position estimation device 101 according to the present example, and is a diagram particularly illustrating the movement during the operation (during a normal operation). During traveling, the own position estimation device 101 updates the own position estimation information 205 based on information periodically acquired from the position information acquisition unit 103 (S100). Then, based on the own position estimation information 205, it is determined whether it is necessary to read next peripheral map information (S110). For example, it is determined whether or not all pieces of map information in a predetermined range based on the own position have been read. If there is a portion that has not been read, it is determined that it is necessary to read next peripheral map information. In a case where the next peripheral map information needs to be read, the peripheral map information that is not used is deleted from the non-volatile memory (S120). At this time, corresponding portions of both the encrypted peripheral map information 109 and the decrypted peripheral map information 108 are deleted.

After the non-volatile memory 104 becomes available by deletion, the encrypted peripheral map information 109 is read and copied to the non-volatile memory 104 based on a range in which the peripheral map is necessary (S130). Thereafter, the encrypted peripheral map information 109 newly loaded into the non-volatile memory 104 is decrypted while being read by the microcomputer 102, and the decrypted peripheral map information 108 is written on the non-volatile memory (S140).

As described above, the non-volatile memory 104 stores the own position information (for example, the own position estimation information 205), the encrypted peripheral map information (for example, the encrypted peripheral map information 109), and the decrypted peripheral map information (for example, the decrypted peripheral map information 108) during the operation of the vehicle.

After the decryption of the decrypted peripheral map information 108 is completed, information necessary for driving assistance is provided to the driving assistance device based on the own position estimation information 205 and the information included in the decrypted peripheral map information 108 (S150). As described above, the microcomputer 102 reads the map information, performs calculation based on the information obtained from the position information acquisition unit 103, and outputs driving assistance information. The driving assistance information includes, for example, information regarding a speed limit, information regarding a sharp curve, information regarding a gradient of a road, and the like.

In a case where it is determined in S110 that the next peripheral map reading is unnecessary, the information necessary for driving assistance is provided to the driving assistance device based on the own position estimation information 205 and information of the decrypted peripheral map information 108 currently on the non-volatile memory 104 (S150). As described above, according to the own position estimation device 101 according to the present example, even in a case where the inexpensive microcomputer 102 that does not have the DRAM I/F and has a relatively small RAM size is used, it is possible to handle practical map data and thus it is possible to reduce the cost of the own position estimation device 101.

### Example 2

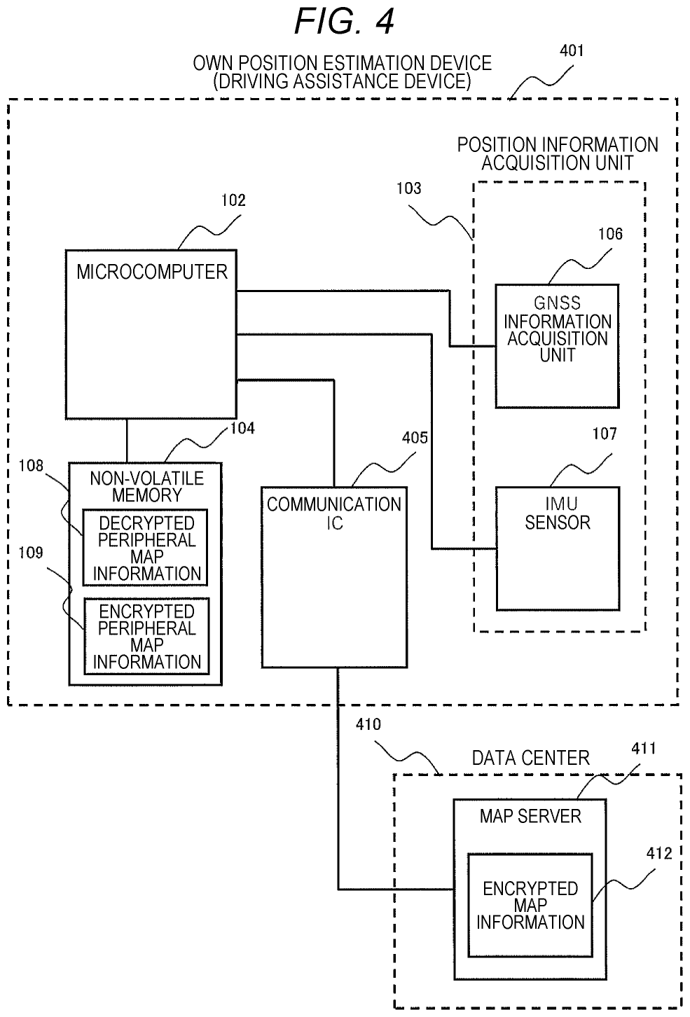

FIG. 4 illustrates a configuration of an own position estimation device according to Example 2 of the present invention. Hereinafter, description of parts common to Example 1 may be omitted.

An own position estimation device 401 includes a microcomputer 102, a position information acquisition unit 103 in a vehicle, a non-volatile memory 104 (memory), and a communication IC 405 (network interface).

The position information acquisition unit 103 (more specifically, a GNSS information acquisition unit 106 and an IMU sensor 107), the communication IC 405, and the non-volatile memory 104 are connected to the microcomputer 102 through a communication line.

The communication IC 405 is connected to a map server 411 in a data center 410 via a network. In response to a request representing a specific region from the communication IC 405, the map server 411 acquires map information of this region from encrypted map information 412 of a wide area and transmits the acquired map information to the communication IC. The communication IC 405 receives the map information and transfers the map information to the microcomputer 102.

Peripheral map information is stored in the non-volatile memory 104. The peripheral map information includes the received encrypted peripheral map information 109 and decrypted peripheral map information 108 created by decrypting the encrypted peripheral map information.

As described above, the non-volatile memory 104 retains the encrypted map information (for example, the encrypted peripheral map information 109) acquired and transferred by the microcomputer 102 via the network and the current position information (for example, own position estimation information).

The non-volatile memory 104 is not limited to the described memory as long as the non-volatile memory has the same characteristics as the non-volatile memory 104 according to Example 1. In addition, the communication IC 405 is an IC that is connectable to an external network such as Ethernet (registered trademark) and is compatible with a communication scheme capable of handling large-capacity data such as map data, but the communication scheme is not limited thereto.

In addition, the type of the sensor of the position information acquisition unit 103 is not limited similarly to the position information acquisition unit 103 according to Example 1.

Further, the encryption scheme of the encrypted map information 412 and the encrypted peripheral map information 109 is not limited, and may be obfuscated instead of so-called encryption.

The operation of the own position estimation device 401 according to Example 2 conforms to the operation of the own position estimation device 101 according to Example 1, and there is a difference in whether the storage location of the encrypted map is inside or outside the own position estimation device. Therefore, the map server 411 corresponds to the large-capacity memory 105 in FIG. 1, but the other data flows are similar, and the operation in FIG. 3 is the same as that of the own position estimation device (1) according to Example 1.

In particular, the microcomputer 102 performs calculation based on the information obtained from the position information acquisition unit 103 and outputs driving assistance information. In addition, the non-volatile memory 104 stores the own position information (for example, the own position estimation information 205), the encrypted peripheral map information (for example, the encrypted peripheral map information 109), and the decrypted peripheral map information (for example, the decrypted peripheral map information 108) during the operation of the vehicle.

As described above, according to the own position estimation device 401 according to the present example, even in a case where an inexpensive microcomputer 102 that does not have a DRAM I/F is used, it is possible to acquire peripheral map information from the outside through the Internet or the like and perform calculation. As a result, it is possible to reduce the cost of the own position estimation device.

### Example 3

An own position estimation device according to Example 3 is obtained by adding an operation at the end to the own position estimation device according to Example 1 or 2 from the viewpoint of security. Hereinafter, description of parts common to Example 1 or 2 may be omitted.

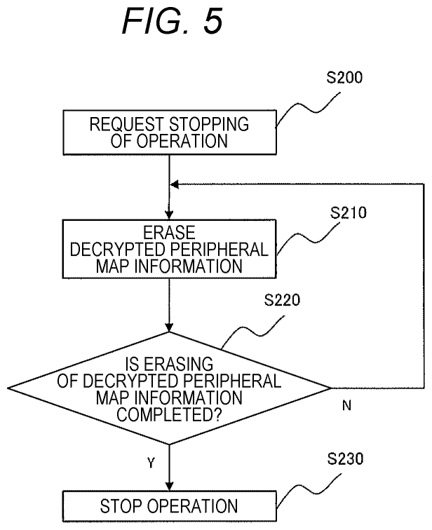

FIG. 5 illustrates a flowchart illustrating a flow of an operation of the own position estimation device according to Example 3. FIG. 5 illustrates processing related to the end of an operation of the own position estimation device.

When an operation stop request (which may be referred to as an end notification) arrives at the own position estimation device due to ignition OFF of an automobile or the like (S200), the own position estimation device erases the decrypted peripheral map information 108 stored in the non-volatile memory 104 (S210). Thereafter, it is confirmed whether the erasing of the decrypted peripheral map information 108 has been completed (S220). In a case where the erasing has not been completed (S220: NO), the erasing processing of the decrypted peripheral map information 108 that has not been erased is performed or continued (S210 described above). As described above, the microcomputer 102 discards the decrypted peripheral map information in response to the operation stop request. When the erasing of the decrypted peripheral map information 108 is confirmed (S220: YES), the operation is stopped (S230).

As a result, it is possible to obtain an effect of preventing reading of the decrypted peripheral map information 108 from the outside after the operation is stopped. That is, it is possible to avoid the risk of extracting the map information from the own position estimation device after traveling.

Even in a case where the own position estimation information 205 and the encrypted peripheral map information 109 are stored in the non-volatile memory 104, the microcomputer 102 does not erase the own position estimation information 205 and the encrypted peripheral map information 109. That is, the microcomputer 102 stores the own position estimation information 205 and the encrypted peripheral map information 109 when the operation is stopped.

### Example 4

An own position estimation device according to Example 4 is capable of executing a start timing of driving assistance early by using the encrypted peripheral map information and the own position estimation information stored in the non-volatile memory at the time of activation, with respect to the own position estimation device according to Example 3. Hereinafter, description of parts common to Example 3 may be omitted.

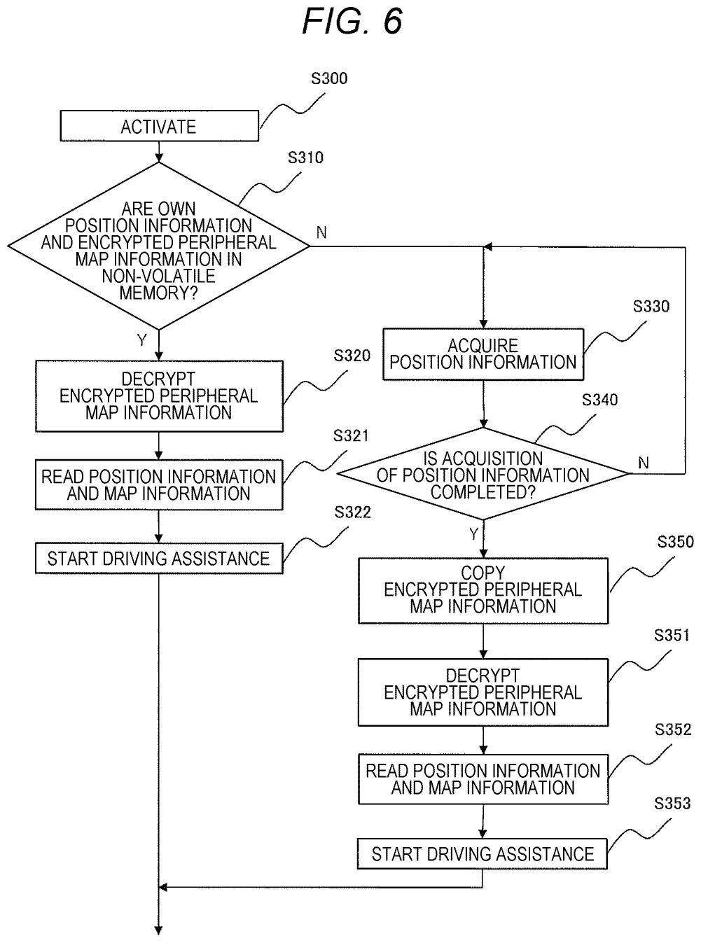

FIG. 6 illustrates a flow of an operation of the own position estimation device according to Example 4. FIG. 6 illustrates an operation related to activation of the own position estimation device.

When the own position estimation device is activated by the ignition ON of the automobile or the like (S300), the own position estimation device confirms whether the own position estimation information 205 and the encrypted peripheral map information 109 are stored in the non-volatile memory 104 (S310). As described above, in response to the activation of the vehicle, the microcomputer 102 refers to the own position estimation information 205 and the encrypted peripheral map information 109 stored in the non-volatile memory 104.

In a case where the own position estimation information 205 and the encrypted peripheral map information 109 are stored (S310: YES), the encrypted peripheral map information 109 is decrypted (S320). As described above, in a case where the own position estimation information 205 and the encrypted peripheral map information 109 are present in the non-volatile memory 104, the microcomputer 102 decrypts the encrypted peripheral map information 109 and stores the decrypted peripheral map information in the non-volatile memory 104.

When the output of the decrypted peripheral map information 108 to the non-volatile memory is completed, the own position estimation information 205 and the decrypted peripheral map information 108 are read, and calculation of information necessary for driving assistance is started based on these pieces of information (S321), and the driving assistance is started (S322). As described above, the microcomputer 102 outputs the driving assistance information by using the own position estimation information 205 and the decrypted peripheral map information 108.

Since the processing up to this point does not require the GNSS, it is possible to obtain an effect that it is possible to start the driving assistance at an earlier timing than in a configuration in which the own position is estimated from information of the GNSS or the like and the encrypted peripheral map information starts to be read after the own position estimation is completed. That is, it is possible to start the driving assistance by own position estimation soon after start, and it is possible to obtain an effect of realizing the driving assistance from the start of driving.

In S320 to S322, any available sensor (IMU sensor 107 or another sensor) may be used. Furthermore, in a case where the GNSS becomes available, when use of information from the GNSS is started at that time, it is possible to perform own position estimation with higher accuracy.

In a case where the encrypted peripheral map information 109 is not stored in the non-volatile memory 104 at the time of initial start or the like (S310: NO), the position information is acquired in the same manner as in the conventional own position estimation device (S330). Whether the acquisition of the position information is completed is repeatedly confirmed (S340). When the acquisition of the position information is completed, necessary encrypted peripheral map information is sequentially copied from the encrypted peripheral map information 109 to the non-volatile memory 104 (S350). The encrypted peripheral map information 109 is decrypted (S351). The own position estimation information 205 and the decrypted peripheral map information 108 are read (S352). Calculation of information necessary for driving assistance is started based on these pieces of information, and the driving assistance is started (S353).

In this case, it is not possible to obtain the effect of shortening the time from the start to the start of the driving assistance. However, the own position estimation information 205 and the encrypted peripheral map information 109 remain in the non-volatile memory at the end of the normal operation (see Example 3), and thus the case where it is not possible to obtain the effect is limited to a small part.

### Example 5

A driving assistance device according to the present example is configured such that a device that is any one of the own position estimation devices according to Examples 1 to 4, performs own position estimation, and outputs driving assistance information simultaneously performs the driving assistance by using the information. That is, the own position estimation device 101 or 401 also functions as the driving assistance device. Hereinafter, description of parts common to any one of Examples 1 to 4 may be omitted.

For example, the microcomputer 102 has a multi-core configuration, that is, includes a plurality of processors. Then, one or more of the plurality of processors realize the own position estimation device according to any one of Examples 1 to 4, and another one or more of the plurality of processors realize the driving assistance device.

As described above, the driving assistance device according to the present example includes the own position estimation device and has the own position estimation function. Then, the driving assistance device has a function of performing the driving assistance by using the own position estimated by the own position estimation function.

Although the specific contents of the driving assistance are not particularly limited, those skilled in the art can appropriately perform design based on a known technique or the like, and can assist operations related to, for example, an accelerator, a brake, steering, and the like.

As the effect of the own position estimation device according to Examples 1 to 4, the role of the own position estimation device can be performed by an inexpensive microcomputer. Thus, the own position estimation device can be integrated with a driving assistance device realized by an inexpensive microcomputer, and it is possible to obtain an effect that highly functional driving assistance based on own position estimation can be realized even by a driving assistance device having low cost. That is, it is possible to integrate a device on the side on which the own position estimation function is provided, and a device on the side in which the driving assistance is performed by using information provided by the own position estimation device.

### REFERENCE SIGNS LIST

101 own position estimation device (driving assistance device)
102 microcomputer
103 position information acquisition unit
104 non-volatile memory (second memory)
105 large-capacity memory (first memory)
106 GNSS information acquisition unit
107 IMU sensor
108 decrypted peripheral map information (decrypted peripheral map information)
109 encrypted peripheral map information (encrypted peripheral map information)
110 encrypted map information
205 own position estimation information (own position information)
401 own position estimation device (driving assistance device)
405 communication IC (network interface)

1. An own position estimation device comprising:
a position information acquisition unit in a vehicle;
a first memory in which encrypted map information is stored;
a microcomputer that reads the map information, performs calculation based on information obtained from the position information acquisition unit, and outputs driving assistance information; and
a second memory that retains the map information and current position information transferred by the microcomputer,
wherein the position information acquisition unit, the first memory, and the second memory are connected to the microcomputer through a communication line, and
the second memory is a non-volatile memory of the vehicle, and stores own position information, encrypted peripheral map information, and decrypted peripheral map information during an operation of the vehicle.

2. An own position estimation device comprising:
a position information acquisition unit in a vehicle;
a microcomputer that performs calculation based on information obtained from the position information acquisition unit and outputs driving assistance information; and
a memory that retains encrypted map information and current position information acquired and transferred by the microcomputer through a network interface,
wherein the position information acquisition unit, the network interface, and the memory are connected to the microcomputer through a communication line, and
the memory is a non-volatile memory of the vehicle, and stores own position information, encrypted peripheral map information, and decrypted peripheral map information during an operation of the vehicle.

3. The own position estimation device according to claim 1,
wherein the microcomputer discards the decrypted peripheral map information in response to an operation stop request, and
the microcomputer stores the own position information and the encrypted peripheral map information when the microcomputer stops operating.

4. The own position estimation device according to claim 1,
wherein the microcomputer refers to the own position information and the encrypted peripheral map information stored in the second memory in response to activation of the vehicle,
the microcomputer decrypts the encrypted peripheral map information and stores a decryption result in the second memory in a case where the own position information and the encrypted peripheral map information are included in the second memory, and
the microcomputer outputs the driving assistance information by using the own position information and decrypted peripheral map information.

5. The own position estimation device according to claim 1,
wherein the second memory is an MRAM, a FeRAM, a ReRAM, a PRAM, or an NRAM.

6. A driving assistance device comprising:
the own position estimation device according to claim 1, wherein
an own position estimation function, and a function of performing driving assistance by using an own position estimated by the own position estimation function are provided.
